(19) United States
(12) Patent Application Publication
(10) Pub. No.: US 2011/0013095 A1
(43) Pub. Date: Jan. 20, 2011

(54) Portable Projector

(75) Inventors: Meir Aloni, Herzelia (IL); Gady Yearim, Haifa (IL); Elisha-Avraham Tal, Hare Yehuda (IL); Jacob Rand, Herzlia (IL); Eyal Cremer, Kiryat Haim (IL)

Correspondence Address: HOUSTON ELISEEVA LLP, Suite 4, 4 Militia Drive, Lexington, MA, 02421, US

(73) Assignee: X.D.M. LTD., Herzliya (IL)

(21) Appl. No.: 12/817,500

(22) Filed: Jun. 17, 2010

Related U.S. Application Data
(63) Continuation of application No. PCT/IL2008/001642, filed on Dec. 18, 2008.
(60) Provisional application No. 61/008,312, filed on Dec. 20, 2007.
(60) Provisional application No. 61/006,121, filed on Dec. 19, 2007.

(51) Int. Cl. H04N 9/31; H04N 7/12

(52) U.S. Cl. 348/744; 375/240.01; 348/E09.025; 375/E07.076

(57) ABSTRACT

A projector and a system comprising a projector and a handheld device are described. In a preferred embodiment, a projector for projecting an image includes a back section and a front section. The back section has a bottom surface for resting on a supporting surface, and the front section has an optical window for projecting light indicative of the image. The front section is tilted with respect to the bottom surface of the back section to define a tilt angle. The system includes a video-output generating handheld device, and a display device controlled by control signals generated by the handheld device. The handheld device and the display device are interconnected with no more than one physical video signal connection.

### FIELD AND BACKGROUND

Portable projectors are usually constructed in a manner that the optical axis of a projection lens of the projector device is substantially parallel to the enclosure of the projector device or to the bottom surface of the projector device.

When such projectors are placed on a flat surface, like a table top, and need to project an image above this surface, one of two following alternatives can be used:

1. The entire projector device needs to be angled upward (tilted) relative to the flat surface, in order to cover the screen area with the projected image.

2. The projector is built using an offset projection lens. This lens is built with an optical offset, relative to the optical axis of the system.

In order to enable implementation of the alternative 1, a leg mechanism needs to be incorporated into the projector, which complicates the design and the operation of the portable projector. Alternatively, the projector can be placed on an external heightening device that will tilt the whole projector body.

As for the alternative 2 it suffers from the fact that an offset lens diameter is larger than a non-offset lens diameter, thus making the entire device more bulk, complex and expensive.

Portable projectors sometimes get their input from hand held devices.

Hand-held devices like mobile phones, portable media players and alike have become very common recently. Some of these devices are capable of outputting video and audio content to an external device like a screen or a projector. The term “video” here refers to any visual data, including, for example, static images and video. A common practice for handheld devices is to use standard interfaces for this output. A very common interface on many devices is the analog Composite or S-Video interface (like PAL or NTSC or SECAM), or digital interfaces like BT601/656 and alike. These interfaces are capable of carrying the video content, but do not have any defined provisions for control of external devices, nor were they designed to control external display devices.

General Description of the Invention

One aspect of the present invention concerns a novel portable projector device. Another aspect of the present invention concerns a hand held device configured for interfacing with a portable projector or other display device and controlling the display device from the hand-held device. Some embodiments embody both aspects of the invention.

In an exemplary embodiment, a portable projector device has a front section, with a projection opening, and a back section. The device is configured such that the front section is angled (tilted) relative to the back section, i.e. relative to a bottom surface of the back section.

This design allows placing the portable projector flat and horizontal on a flat surface, while the projection part has a built-in angle relative to this surface, thus preventing the need for tilting the entire projector relative to the supporting surface when placing the back section of the projector on said surface.

The angle of the front projection part with respect to the bottom surface of the back part of the enclosure can be fixed or can be adjustable, e.g. by using a hinge or flexible joint between the front part and the back part of the projector.

In some embodiments, a constant angle is fitted into the projector, and a predefined electronic keystone correction is incorporated into the design of the projector, in order to allow for correction of the known keystone distortion. If a hinge is fitted into the projector, which enables changing the projection angle, then a programmable electronic keystone correction can be optionally incorporated into the design of the projector, in order to allow for correction of the known keystone distortion.

It should be noted that the hinged-type projector also allows placing the projector device on a horizontal surface while projecting on the ceiling.

When connecting a video output of a hand-held device, to a portable projector, LCD display or other display device using standard interfaces, it is often desired to send control commands from the hand-held device to the display device in order to control the operation and performance of the display device. Typical control commands include, but not limited to command to turn on or off the display device, increase or decrease the display brightness, change display contrast, change display colors, or in the case of portable projector display device—change its keystone correction or color temperature setting. Sending initial setting parameters is also a kind of control parameters that the handheld device might need to send to the display device for proper operation.

The need for sending control information to the display device can arise from many reasons. One reason may be that the display device does not have any, or sufficient, control keys or control means for its control. Another reason maybe that there is a need to control the display the same way and by the same means that the handheld device controls its internal display—literally, using its MMI (man machine interface) structure. Additionally, controlling the display device from the handheld device will usually be simpler to operate than control from the display device itself, cheaper to implement, and can reduce the visual artifacts that may happen when pushing control keys on the display device, when the display is a portable projector. It is also more natural to control the display device functions (see above examples) from the same device and by the same means that the displayed content is controlled. In view of the above, the inventors realized that it is desirable to have the capability to send control information from the handheld device to the display device.

In an exemplary embodiment, a handheld device sends control information to the display device via signal group connection (for example, SPI, I2C, RS232, GPIB, and/or custom control bus) going from the handheld device to the display device. This control data is preferably sent together with video data (before, during or after the display of video content) with the video data that the handheld device generates and sends for display to the display device. Having a cable with two signal groups—control group and video group is usually too complex and expensive to implement for a low cost handheld environment, and moreover is not standardized or currently used by any handheld device. It requires additional dedicated wires that do not fit to most AV connections today.

Thus, in an exemplary embodiment, control information is added to (or control information is embedded in) the video signal group, together with the video information, thus saving the extra control signal group.

The video signal (either analog video or digital video) allows sending non-video data in video intervals that are not displayed, which is usually called VBI—Vertical Blanking Intervals. It should be understood that although in the description below the use of Vertical Blanking Intervals is exemplified, an input for receiving video data may utilize any other blanking interval which is an interval during which active video is not sent (i.e. interval that does not include active video data).

An aspect of some embodiments of the invention provides for allowing commands from the handheld device to be added to the video signal without adding any new physical control lines, which is particularly desirable when dealing with portable handheld devices. Thus, according to an embodiment of the invention, a handheld device is configured for adding control commands and setting information to a video signal generated by said hand held device without adding a separate physical link. In an exemplary embodiment, defining a command data structure suitable for display device control, and using a data insertion mechanism during blanking intervals, e.g. Vertical Blanking Intervals (VBI), control data are added to the video signal in a very economic way, without changing the physical connection, and with full compatibility to drive display devices that do not have this control over VBI method.

Thus, in a preferred embodiment, a portable, optionally handheld, imaging device is configured and operable for generating a video output signal for being displayed by a display device, and adding control data to the video signal without adding new physical connection, and without affecting display devices that were not designed to react to this control data.

Thus, in accordance with an exemplary embodiment, there is provided a projector for projecting an image, the projector comprising:

a back section having a bottom surface for resting on a supporting surface; and

a front section comprising an optical window for projecting light indicative of the image,

wherein the front section is tilted with respect to the bottom surface of the back section to define a tilt angle.

Optionally, the tilt angle is between 5° and 90°.

In some embodiments, the tilt angle is fixed. Optionally, a projector with a fixed tilt angle comprises a predefined electronic keystone correction.

In some embodiments, the projector comprises a tilt adjusting member for adjusting the tilt angle.

Optionally, the tilt adjusting member adjusts the tilt angle to angles between 0° and 90°.

In some embodiments, the tilt adjusting member comprises a hinge or flexible joint between said front part back sections.

Some embodiments with adjustable tilt angle comprise a programmable electronic keystone correcting module.

In an exemplary embodiment, the projector comprises:

an input for receiving video data comprising blanking intervals from a handheld device;

a decoder configured to decode control information encoded in said blanking intervals; and

a controller, receiving control information from said decoder and controlling the projector in accordance with said control information.

It is further provided in accordance with an exemplary embodiment a video-output generating handheld device comprising:

a video generator, generating video with blanking intervals;

a first controller, receiving and/or generating control information for controlling an external display device; and

a coding module, receiving control information from said controller, and encoding the received control information into the blanking intervals of the video generated by the video generator.

An exemplary embodiment provides a system comprising:

a video-output generating handheld device according to claim 10

a display device controlled by control signals generated by said handheld device,

wherein said handheld device and display device are interconnected with no more than one physical video signal connection.

In some embodiments, the display device comprises:

an input for receiving video data comprising banking itervals from the handheld device;

a decoder configured to decode control information encoded in said banking itervals; and

a second controller, receiving control information from said decoder and controlling the display device in accordance with said control information.

There is also provided in accordance with an exemplary embodiment a display device comprising:

an input for receiving video data comprising banking itervals from a video-output generating device;

a decoder configured to decode control information encoded in said banking itervals; and

a controller, receiving control information from said decoder and controlling the display device in accordance with said control information.

Optionally, the blanking intervals include vertical blanking intervals.

### BRIEF DESCRIPTION OF THE DRAWINGS

FIGS. 1A and 1B are pictorial illustrations of a projector according to an embodiment of the invention;

FIG. 2 is a schematic illustration of a projector having a fixed tilt angle according to an embodiment of the invention;

FIG. 3 is a schematic illustration of a projector having a controllable tilt angle according to an embodiment of the invention;

FIG. 4 is a block diagram of a system allowing controlling a display device from a handheld video-output generating device according to an embodiment of the invention.

### DESCRIPTION OF EXEMPLARY EMBODIMENTS

In order to understand the invention and to see how it may be carried out in practice, preferred embodiments will now be described, by way of non-limiting examples only, with reference to the accompanying drawings, in which:

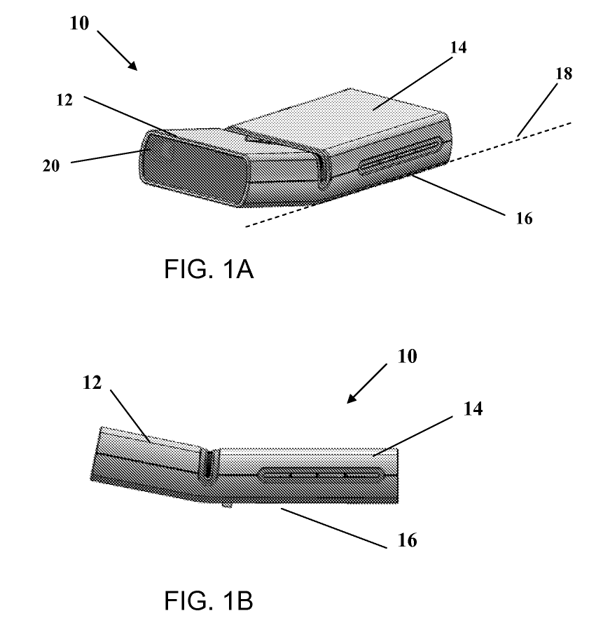

FIGS. 1A and 1B illustrate the design of a projector according to one embodiment of the invention, generally designated 10. The configuration of projector 10 defines a front section or part 12 and a back section or part 14. The front part 12 is tilted a certain tilt angle with respect to a plane defined by the back part 14, i.e. with respect to a bottom surface 16 of the back part 14. The tilt angle is optionally between about 5° and about 90°. Some exemplary tilt angles are 5, 10, 20, 30, 45, 60, and 90°. The front part 12 of the projector device 10 has a facet 20 in which an optical window, which is optionally an opening, is provided to output through the optical window light indicative of a projected image. When device 10 is placed on a supporting surface 18, the bottom surface 16 of the back part 14 engages and extends along the supporting surface 18, while the front part 12 is tilted with respect to the bottom/supporting surface.

The two parts 12 and 14 are optionally coupled to each other either to form an integral two-part structure with a contact tilt angle between them. Alternatively or additionally, the two parts are coupled to form two connectable parts with an adjustable angle between them.

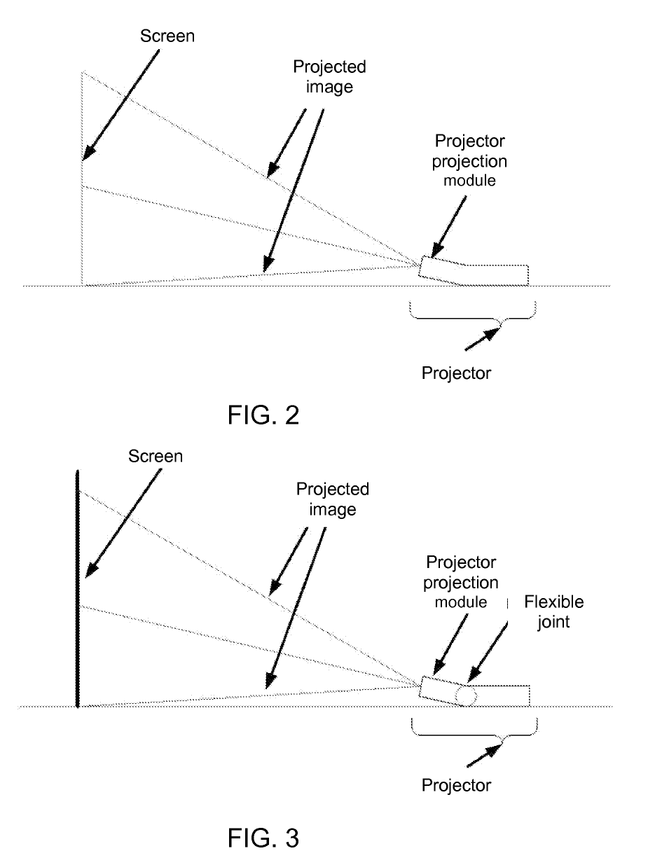

FIG. 2 shows the two-part projector device 10 with a constant angle between the front part (termed “projection module”) and the back part by which the device is placed on a supporting surface. As shown, light indicative of a projected image is output from the device through an optical window on the facet of the projection module and propagates towards a screen.

FIG. 3 shows the two-part projector device with the two parts, projection module (front part) and the back part being coupled to one another via a flexible joint, allowing angular displacement of one part with respect to the other. By this, a tilt angle of the projection module with respect to the back part (its bottom surface) can be appropriately adjusted. Optionally, the flexible joint, or any other tilt adjusting member is adapted for adjusting the tilt angle to angles between 0° and 90°. For example, in some embodiments, the tilt adjusting member is capable of adjusting the tilt to any angle between 0° and 30°. In some embodiments, the tilt adjusting member adjusts the tilt only to some predetermined angles, for instance 0, 5, 10, or 15°.

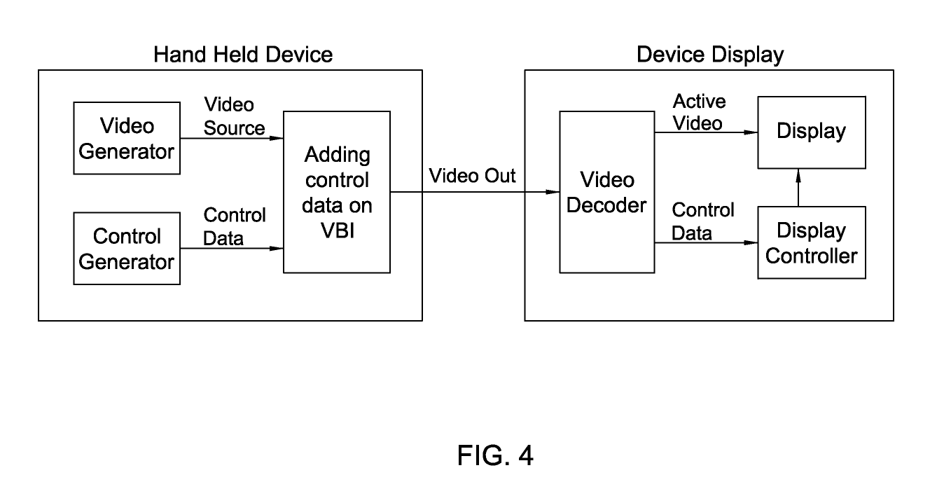

FIG. 4 illustrates a block diagram describing controlling a display device from a handheld video outputting device using single video line to send real time video and control data from the hand held device to the display device. The hand held device includes inter alia a video signal generator and a control data generator. The display device includes a video decoder, a display panel and a display controller.

The hand held device according to the embodiment shown, comprises a data processing utility that receives the video signal and the control data and adds control information corresponding to the control data to the non displayed vertical blanking interval (called VBI) of the video signal. The display device receives a combined signal, comprising the video and the control information, and operates to decode the video signal and to separate the control information from the video information. The control information is then used by the display controller to control the display, for example to increase or decrease display brightness.

1. A projector for projecting an image, the projector comprising:
a back section having a bottom surface for resting on a supporting surface; and
a front section comprising an optical window for projecting light indicative of the image,
wherein the front section is tilted with respect to the bottom surface of the back section to define a tilt angle.

2. A projector according to claim 1, wherein the tilt angle is between 5° and 90°.

3. A projector according to claim 1, wherein the tilt angle is fixed.

4. A projector according to claim 3, comprising a predefined electronic keystone correction.

5. A projector according to claim 1, comprising a tilt adjusting member for adjusting the tilt angle.

6. A projector according to claim 5, where said tilt adjusting member adjusts the tilt angle to angles between 0° and 90 °

7. A projector according to claim 5, wherein said tilt adjusting member comprises a hinge or flexible joint between said front part back sections.

8. A projector according to claim 5, comprising a programmable electronic keystone correcting module.

9. A projector according to claim 1, comprising:
an input for receiving video data comprising blanking intervals from a handheld device;
a decoder configured to decode control information encoded in said blanking intervals; and
a controller, receiving control information from said decoder and controlling the projector in accordance with said control information.

10. A video-output generating handheld device comprising:
a video generator, generating video with blanking intervals;
a first controller, receiving and/or generating control information for controlling an external display device; and
a coding module, receiving control information from said controller, and encoding the received control information into the blanking intervals of the video generated by the video generator.

11. A system comprising:
a video-output generating handheld device according to claim 10
a display device controlled by control signals generated by said handheld device, wherein said handheld device and display device are interconnected with no more than one physical video signal connection.

12. A system according to claim 10, wherein said display device comprises:
an input for receiving video data comprising blanking intervals from the handheld device;
a decoder configured to decode control information encoded in said blanking intervals; and
a second controller, receiving control information from said decoder and controlling the display device in accordance with said control information.

13. A display device comprising:
an input for receiving video data comprising blanking intervals from a video-output generating device;
a decoder configured to decode control information encoded in said blanking intervals; and
a controller, receiving control information from said decoder and controlling the display device in accordance with said control information.

14. A projector according to claim 9, wherein said blanking intervals are vertical blanking intervals.

15. A video-output generating handheld device according to claim 10, wherein said blanking intervals are vertical blanking intervals.

16. A system according to claim 12, wherein said blanking intervals are vertical blanking intervals.

17. A display device according to claim 13, wherein said blanking intervals are vertical blanking intervals.
